(19) United States
(12) Patent Application Publication
(10) Pub. No.: US 2010/0171606 A1
(43) Pub. Date: Jul. 8, 2010

(54) Flexible Light Bar

(76) Inventors: Calvin Chuen Kam Law, Chino, CA (US); George Chion Feng Lee, Brea, CA (US)

Correspondence Address: AGNEW INTERNATIONAL;PATENT & TRADEMARK LAW FIRM, 7700 Irvine Center Drive, SUITE 800, Irvine, CA, 92618, US

(21) Appl. No.: 12/504,551

(22) Filed: Jul. 16, 2009

Related U.S. Application Data
(60) Provisional application No. 61/142,949, filed on Jan. 7, 2009.

(51) Int. Cl. B60Q 1/26

(52) U.S. Cl. 340/468

(57) ABSTRACT

A light bar apparatus is disclosed. The light bar apparatus is attached to a vehicle and comprises a plurality of LED lights capable of illuminating in patterns signaled by the vehicle. The light bar is made at least in part of flexible material such that the body is capable of being rolled up to reduce the shipping footprint.

### CROSS REFERENCE TO RELATED APPLICATION

This application claims the benefit of priority under 35 U.S.C. 119(e) to the filing date of U.S. provisional patent application No. 61/142,949 entitled “Flexible Light Bar” which was filed on Jan. 7, 2009 and is incorporated herein by reference.

### FIELD OF THE INVENTION

The present invention relates generally to a vehicular lighting device. Specifically, the present invention is related to a vehicular lighting device which displays the signals of a vehicle along an elongated bar affixed to the rear of the vehicle, where such a bar is made of flexible material.

### BACKGROUND OF THE INVENTION

Over the last few years, LED light bars have seen an increase in demand as consumers seek novel ways to accessorize and customize their vehicles while also gaining added safety. LED-based lighting is becoming very popular for several reasons; Light-emitting diodes are small, completely solid state, very power-efficient, and have very long lives having no filaments to burn out. These LED light bars work as running lights, brake lights, turn signals and feature bright, white LED reverse lights.

Typically, the light bar is installed to the rear of the vehicle and connected to a vehicle's standard 4-pin flat trailer light connector. The light bar reproduces the appropriate light sequence that built-in lights on rear of the vehicle would produce for a given situation: (1) by functioning as running lights by default. (2) The entire light bar is illuminated when braking. (3) The left half of the light bar flashes when a left turn is signaled. (4) The right half of the light bar flashes when a right turn is signaled. (5) When the vehicle is shifted into reverse and the light bar automatically switches to backup light up mode, which turns on white LEDs. These powerful, white LEDs create a “safety zone” behind the vehicle for safe, confident maneuvering.

Consumers can also attach the light bar between the tailgate and bumper as a stylish aftermarket makeover for their truck. Auto enthusiasts often seek new ways to distinguish their vehicle from the stock model by accessorizing the exterior of their vehicle with aftermarket parts including but not limited to light bulbs, light covers, rims, and body kits.

Light bars are typically made of solid and rigid, plastic material. A limiting factor to the economic viability of light bars has been their associated shipping costs. A light bar's rigid, lengthy structure requires the packaging to be relatively large to accommodate its immense size. A typical light bar measures between 48″ to 60″, covering the entire length of the rear face of the truck. Due to the enormous length, light bars are difficult to ship via couriers, resulting in a substantial increase in overall cost of production.

The present invention provides for a light bar acting as running lights, brake lights, turn signals and backup lights wherein the light bar is made of flexible material, wherein the material is preferably a rubber-like material. In one preferred embodiment, one can roll up the light bar in a small package, thereby substantially lowering the difficulty and cost of shipping.

### OBJECT OF THE INVENTION

It is an object of this invention to create an apparatus, made of flexible material capable of being rolled up, which functions as running lights, brake lights, turning signals, and reverse lights.

### SUMMARY OF THE INVENTION

The present invention comprises an apparatus suitable for use as a light bar that is capable of being rolled up.

In one embodiment, the light bar apparatus comprises of a plurality red LED lights whereby said red LED lights are capable of lighting up in specific patterns with respect to whether the vehicle is in motion, engaging its brakes, or indicating an imminent turn to the left or right.

In one embodiment, a plurality of amber LED lights is evenly interspersed between red LED lights. Said amber LED lights are capable of lighting up in specific patterns, indicating an imminent turn of the vehicle to the left or to the right.

In one embodiment, a plurality of white led lights is evenly interspersed between the red LED lights. Said white LED lights are capable of lighting up to signal a vehicle engaged in reverse motion.

In one embodiment, the light bar is preferably constructed at least in part of a flexible material such as plastic.

### BRIEF DESCRIPTION OF THE DRAWINGS

FIG. 1 is an up close drawing of a segment of one embodiment of a light bar in accordance with the present invention,

FIG. 2 is a drawing from a top right view of the embodiment of a light bar in FIG. 1 partially rolled up.

FIG. 3 is a drawing of the light bar apparatus affixed to the rear of a vehicle.

### DETAILED DESCRIPTION OF THE EMBODIMENTS

The present invention is a flexible light bar. In the following description, specific details are set forth in order to provide a more thorough description of the present invention. It will be apparent, however, to one skilled in the art, that the present invention may be practiced without these specific details. In other instances, well-known features have not been described in detail so as not to obscure the invention.

The present invention comprises a lengthy structure suitable for placement at the rear of the vehicle where a plurality of LED lights are strung together for signaling the vehicle's current state. The light bar shell is constructed at least in part of flexible material such as rubber, plastic, metal mesh, silicone tubing, and nylon. The flexible material allows the shell to be pliable, allowing it to be rolled up, resulting in a smaller shipping footprint.

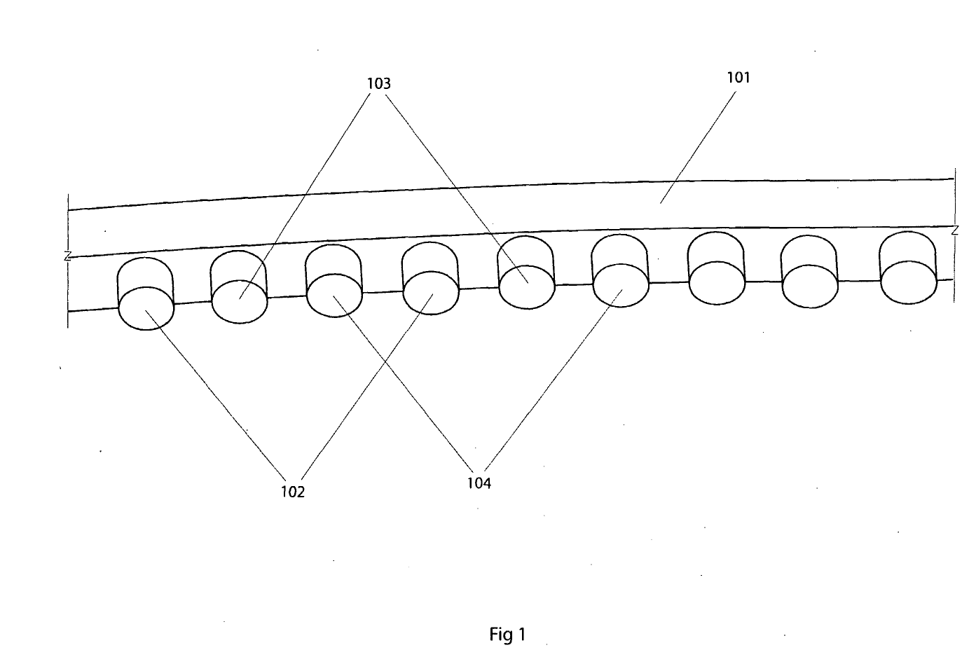

One embodiment of a light bar in accordance with the present invention will be described with reference to FIGS. 1, 2, and 3. Specifically, light bar is of the type that is placed on or affixed to the rear bumper of a truck and includes red, white, and amber LED lights.

In FIG. 1, in one embodiment, the light bar generally comprises a flexible body 101. The body 101 of the light bar comprises a plurality of red 102, white 103, and amber 104 LED lights connected together along the length of the structure. A trailer hitch adapter 105 connects to a vehicle's trailer hitch plug to receive power and signal input.

The flexible light bar is affixed to the rear of the vehicle by adhesive pads to either the top (pointing towards the sky) of the rear bumper or the face (pointing out to the rear) of the rear bumper. The flexible light bar can also be affixed by other methods and materials such as magnets and glues. When correctly installed onto the rear of a vehicle, the LEDs of the light bar face outward from the rear of the vehicle and the back of the light bar faces inwards towards the rear of the vehicle.

In the same embodiment, the flexible light bar contains red LED lights 102 that illuminate in accordance to the signal input received from the vehicle by way of the trailer hitch adapter 105 of the light bar connected to the trailer hitch plug of the vehicle. All of the red LED lights 102 illuminate to signal a vehicle engaged in braking. The red LED lights 102 on the left half of the light bar body 101 illuminate to signal a vehicle's intent to change direction to the left. The red LED lights 102 on the right half of the light bar body 101 illuminate to signal a vehicle's intent to change direction to the right.

In the same embodiment, the flexible light bar contains white LED lights 103 that illuminate in accordance to the signal input received from the vehicle by way of the trailer hitch adapter 105 of the light bar connected to the trailer hitch plug of the vehicle. All of the white LED lights 103 illuminate to signal a vehicle engaged in reverse motion.

In the same embodiment, the flexible light bar contains amber LED lights 104 that illuminate in accordance to the signal input received from the vehicle by way of the trailer hitch adapter 105 of the light bar connected to the trailer hitch plug of the vehicle. The amber LED lights 104 on the left half of the light bar body 101 illuminate to signal a vehicle's intent to change direction to the left. The amber LED lights 104 on the right half of the light bar body 101 illuminate to signal a vehicle's intent to change direction to the right.

In one embodiment, the length of the flexible light bar is adjustable by adding on additional segments or by removing segments so that the length of the light bar fits the length of the vehicle.

In one embodiment, the LED lights of the flexible light bar can be illuminated at a variable pulse rate as desired by the end user. In one embodiment, the colors of the LED lights are interchangeable as to allow for customization by the end user. In one embodiment, the LED lights of the flexible light bar can be controlled by means independent from the vehicle.

### DETAILED DESCRIPTION OF THE FIGURES

In FIG. 1, an up close drawing of a segment of the flexible light bar apparatus in its natural, elongated state is disclosed. Red LED lights 102 are interspersed along the interior of the flexible body 101 in intervals of three between the white 103 and amber 104 LED lights. White LED lights 103 are interspersed along the interior of the flexible body 101 in intervals of three between the red 102 and amber 104 LED lights. Amber LED lights 104 are interspersed along the interior of the flexible body 101 in intervals of three between the red 102 and white 103 LED lights.

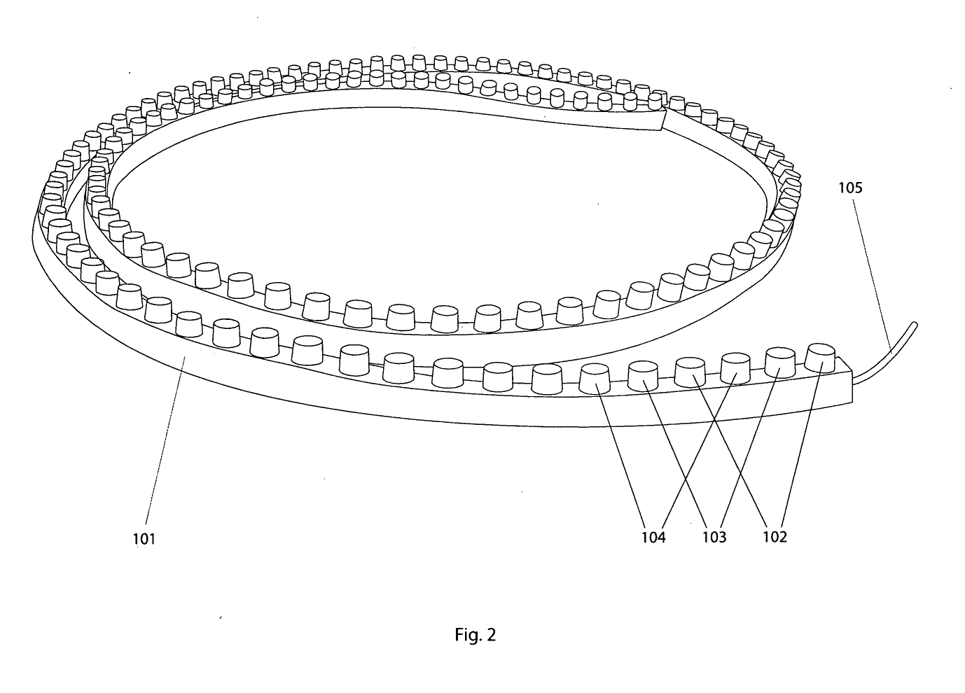

In FIG. 2, a drawing of the flexible light bar apparatus in its rolled up, shipping state is disclosed. Red LED lights 102 are interspersed along the interior of the flexible body 101 in intervals of three between the white 103 and amber 104 LED lights. White LED lights 103 are interspersed along the interior of the flexible body 101 in intervals of three between the red 102 and amber 104 LED lights. Amber LED lights 104 are interspersed along the interior of the flexible body 101 in intervals of three between the red 102 and white 103 LED lights. A trailer hitch adapter 105 extending out from the light bar body 101 connects to a vehicle's trailer hitch plug to receive power and signal input.

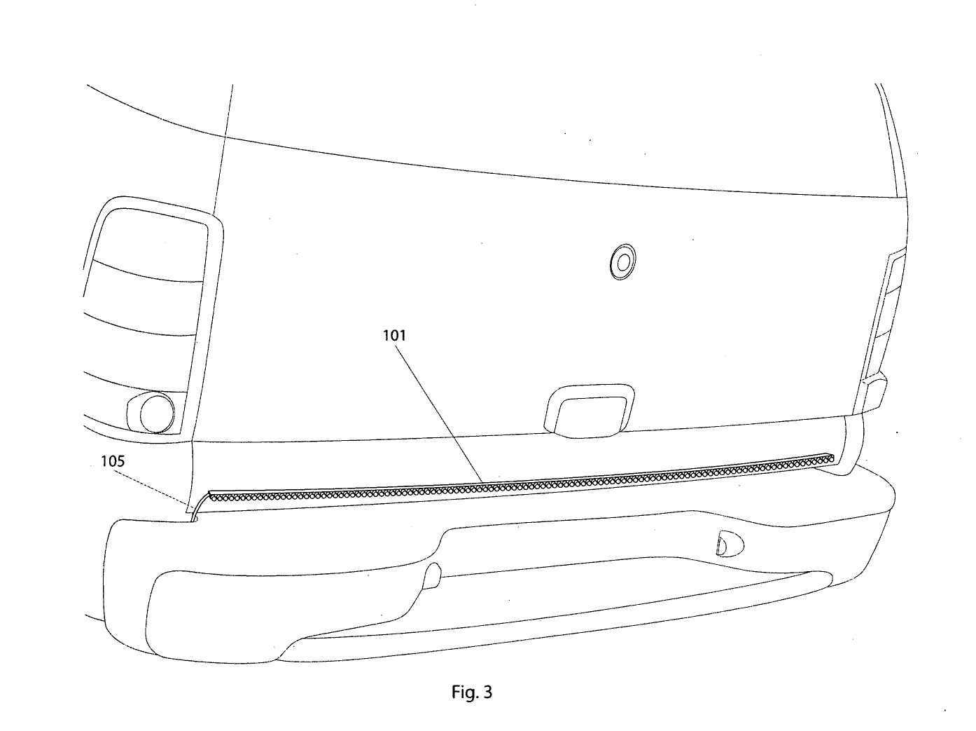

In FIG. 3, a drawing of the flexible light bar apparatus installed upon the rear of a vehicle is disclosed. The LEDs of the light bar are oriented outward away from the vehicle. The rear of the light bar is affixed to the rear of the vehicle. In this drawing, the body 101 of the light bar apparatus is affixed to the back of the vehicle just above the vehicle's bumper. A trailer hitch adapter 105 extending out from the light bar body 101 connects to a vehicle's trailer hitch plug to receive power and signal input.

1. An apparatus for display of vehicle signals comprising:
a. A shell suitable for installation on a vehicle wherein said shell is suitable to house LED lights;
b. A shell constructed at least in part of flexible material;
c. A plurality of LED lights wherein said LED lights are capable of illuminating in a pattern as signaled by said vehicle.

2. The apparatus of claim 1 wherein said LED lights comprises red LED lights wherein said red LED lights are capable of illuminating and functioning as running lights, brake lights, and turn signals.

3. The apparatus of claim 2 wherein said red LED lights are interchangeable with LED lights of other colors.

4. The apparatus of claim 1 wherein said LED lights comprises white LED lights wherein said white LED lights are capable of illuminating and functioning as reverse lights.

5. The apparatus of claim 4 wherein said white LED lights are interchangeable with LED lights of other colors.

6. The apparatus of claim 1 wherein said LED lights comprises amber LED lights wherein said amber LED lights are capable of illuminating and functioning as turn signals.

7. The apparatus of claim 6 wherein said amber LED lights are interchangeable with LED lights of other colors.

8. The apparatus of claim 1 wherein said LED lights can be illuminated at a variable pulsing rate.

9. The apparatus of claim 1 wherein said LED lights can be controlled by means independent from said vehicle.

10. The apparatus of claim 1 wherein said flexible material is rubber.

11. The apparatus of claim 1 wherein said flexible material is plastic.

12. The apparatus of claim 1 wherein said flexible material is metal mesh.

13. The apparatus of claim 1 wherein said flexible material is silicone tubing.

14. The apparatus of claim 1 wherein said flexible material is nylon.

15. The apparatus of claim 1 wherein said apparatus is mounted onto said vehicle by means of adhesive pads.

16. The apparatus of claim 1 wherein said apparatus is mounted onto said vehicle by means of magnets.

17. The apparatus of claim 1 wherein length of said apparatus is expandable through attachment of additional units of said apparatus.

18. The apparatus of claim 1 wherein said apparatus connects directly with said vehicle.

19. The apparatus of claim 1 wherein an adapter is to be connected to said vehicle wherein electricity power and signal input will be provided from said vehicle to said apparatus via an adapter.

20. The apparatus of claim 19 wherein said adapter is a trailer hitch adapter.
